(19) United States
(12) Patent Application Publication
(10) Pub. No.: US 2026/0358615 A1
(43) Pub. Date: Nov. 12, 2026

(54) MICROSCOPE WITH INTERFACE ASSEMBLY HAVING DEFORMABLE WINDOW

(71) Applicant: LIFECANVAS TECHNOLOGIES INC., Cambridge, MA (US)

(72) Inventors: Brian Nguyen, Cambridge, MA (US); Nicholas Bruce Evans, Cambridge, MA (US); Hsuan Lee, Cambridge, MA (US); Caroline Sarah Kornbrek, Boston, MA (US)

(21) Appl. No.: 19/376,866

(22) Filed: Oct. 31, 2025

Related U.S. Application Data
(60) Provisional application No. 63/807,506, filed on May 16, 2025.
(60) Provisional application No. 63/716,110, filed on Nov. 4, 2024.

(51) Int. Cl. G02B 21/33; G02B 21/02; G02B 21/26; G02B 21/34; G02B 21/36

(52) U.S. Cl. CPC G02B 21/33; G02B 21/02; G02B 21/26; G02B 21/34; G02B 21/361

(57) ABSTRACT

A microscopy imaging system includes an interface assembly for interfacing between one or more objectives and a sample holder holding a sample while maintaining gapless contact. The interface assembly may contain a refractive index matched fluid in the light path within a sealed chamber. A deformable interface may be provided between a detection objective and the chamber and/or between the chamber and a sample holder that holds the sample being imaged. The deformable interface may allow for a variety of orientations and positions of the microscope objectives and the samples while maintaining continuity of the immersion media in the optical path.

### CROSS-REFERENCE TO RELATED APPLICATIONS

This application claims the benefit of U.S. Patent Provisional Application No. 63/716,110 filed on Nov. 4, 2024 and U.S. Patent Provisional Application No. 63/807,506 filed on May 16, 2025, each of which are incorporated by reference herein.

### BACKGROUND

Microscopy has long been an important tool in various scientific fields, enabling researchers to observe and analyze structures at the cellular and subcellular level. As imaging technologies have advanced, there has been an increased demand for higher resolution, increased imaging depth, and improved image quality, particularly when examining complex biological samples.

One of the challenges in microscopy is maintaining optical clarity throughout the light path from the sample to the imaging device. Refractive index mismatches between different materials in this path can lead to aberrations and distortions, compromising image quality and resolution. This issue becomes particularly pronounced when imaging thick tissue samples (which may be cleared), where maintaining consistent optical properties across millimeter-scale to centimeter-scale distances can be important.

### BRIEF DESCRIPTION OF THE DRAWINGS

FIGURE(FIG.) 1A is cross-sectional exploded view of select components of an example embodiment of a microscope.

FIG. 1B is cross-sectional view of select components of an example embodiment of a microscope with the components positioned for use.

FIG. 1C is a perspective exploded view of select components of an example embodiment of a microscope.

FIG. 2 is cross-sectional view of select components of a second example embodiment of a microscope.

FIG. 3 is cross-sectional view of select components of a third example embodiment of a microscope.

FIG. 4 is cross-sectional view of select components of a fourth example embodiment of a microscope.

FIG. 5 is cross-sectional view of an example embodiment of a pressurization device for a microscope.

FIG. 6 is cross-sectional view of select components of a fifth example embodiment of a microscope.

### DETAILED DESCRIPTION

The described embodiments include a microscopy imaging system such as a light sheet microscope or other type of microscope that includes a refractive index matched fluid in the light path within a sealed chamber having at least one deformable interface. For example, a deformable interface may be provided between a detection objective and the chamber and/or between the chamber and a sample holder that holds the sample being imaged. The deformable interface may allow for a variety of orientations and positions of the microscope objectives and the samples while maintaining continuity of the immersion media in the optical path. For example, the objectives may be freely moved for refocusing and samples may be freely repositioned while maintaining continuity of the immersion medium in the optical path.

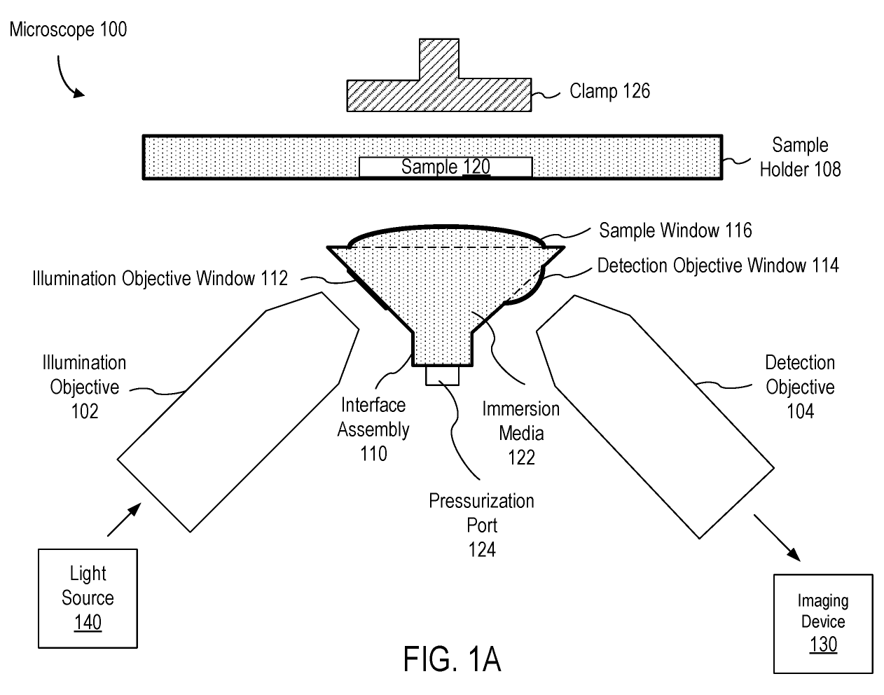

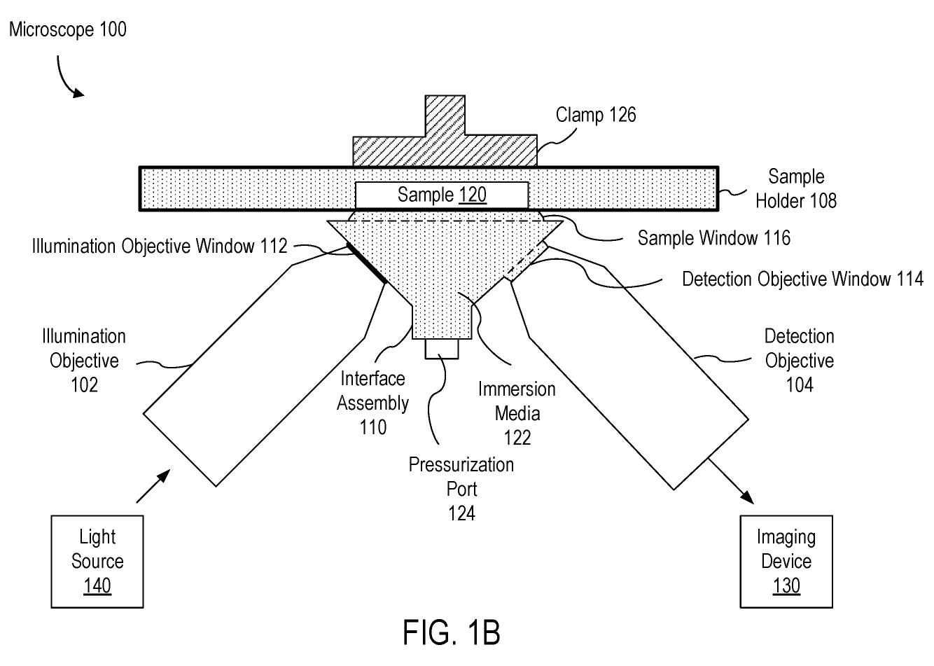

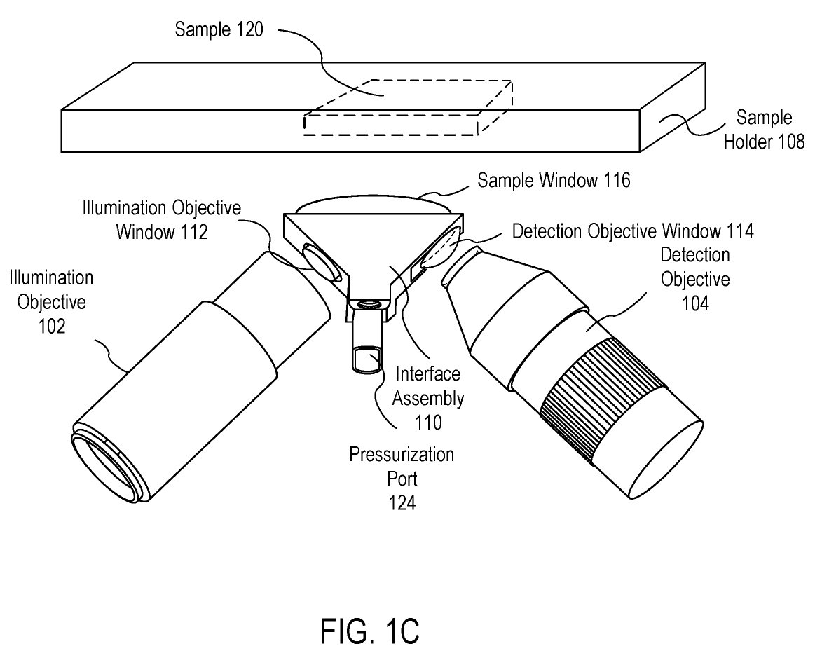

FIGS. 1A-C illustrates a first example configuration of a microscope 100. Particularly FIG. 1A illustrates an exploded cross-sectional view of the individual components while FIG. 1B illustrates a cross-sectional view of the component positions during use. FIG. 1C illustrates a perspective exploded view of the microscope 100 with individual elements separated for clarity of illustration.

The microscope 100 comprises an illumination objective 102 and a detection objective 104 oriented substantially orthogonal to one another. In one implementation, the objectives 102, 104 may be oriented at substantially symmetric angles relative to the plane of the sample 120 (e.g., at 45 degrees relative to a horizontal plane of a sample 120 being imaged). Alternatively, the objectives 102, 104 may be oriented asymmetrically (e.g., at 30 degrees and 60 degrees respectively, at 60 degrees and 30 degrees respectively, or at some other angles). In further embodiments, the objectives 102, 104 may be oriented at non-orthogonal angles. A sample holder 108 supports a sample 120 for imaging. In the illustrated embodiment, the sample holder 108 is positioned above the objectives 102, 104 such that sample 120 can be imaged from below. In operation, the illumination objective 102 directs and focuses excitation light from a light source 140 into the sample 120 to generate an illumination region. The detection objective 104 collects light from the illuminated sample 120 and includes magnifying optics to focus the light onto an image plane for capturing by an imaging device 130. For example, in a light sheet microscope, the illumination objective 102 may produce a substantially planar light sheet that induces fluorescence in the illuminated portion of the sample 120 that is captured by the imaging device 130 via the detection objective 104. The sample holder 108 may be mechanically moved to shift its position relative to the illumination and detection planes, thereby enabling sequential acquisition of different planar image slices throughout the volume of the sample. Alternatively, or in addition, the illumination objective 102 and/or detection objective 104 may be translated and/or otherwise controlled in a coordinated manner to shift the illumination and detection planes relative to the sample 120. The illumination objective 102 and/or the detection objective 104 may also be moved relative to each other to achieve alignment between the illumination and detection planes.

An interface assembly 110 provides optical coupling between the respective objectives 102, 104 and the sample holder 108. The interface assembly 110 may include an illumination objective window 112 and a detection objective window 114 at respective positions and orientations aligned with the illumination objective 102 and the detection objective 104 respectively (e.g., at respective 45 degree angles from the sample plane). The interface assembly 110 may also include a sample window 116 on its top side for optically coupling to the sample 120 via the sample holder 108.

The interface assembly 110 may comprise a substantially rigid chamber that contains an immersion media 122 for refractive index matching between different portions of the light paths. The immersion media 122 may be selected based on its refractive index properties and may be matched to that of the sample 120 to be imaged and other portions of the light paths. In various implementations, the immersion media 122 may comprise, for example, an index matching oil, glycerol, Thiodiethanol, water, aqueous solutions, ethyl cinnamate, dibenzyl ether, or other substance.

The detection objective window 114 may comprise a flexible film that provides a seal to contain the immersion media 122 and deforms in response to external forces from the detection objection 104 and/or internal forces from pressurization of the immersion media 122. The detection objective window 114 thereby allows for movement of the detection objective 104 (while the interface assembly 110 is held stationary) during re-focusing. In some instances, this configuration maintains gapless contact between the detection objective 104 and the detection objective window 114. This avoids air gaps in the light path that can otherwise lead to image quality issues due to refractive index mismatch or other aberrations, particularly in embodiments where the illumination and/or detection light paths are non-orthogonal to interfaces (e.g., the light path through the detection objective window 114 is non-orthogonal to the detection objective window 114). In embodiments, where the detection light path is orthogonal to the interface, such aberrations may still be avoided (or may be small enough to be within tolerance) even with air gaps, and some separation between the detection objective and the detection objective window 114 may therefore be permissible. In some embodiments, a rigid detection objective window 114 may be used in embodiments where the light path is orthogonal to the detection objective window 114.

The sample window 116 may also comprise a flexible film of similar or identical material to the detection objective window 114. The sample window 116 is deformable in response to external forces from the sample holder 108 or internal forces from pressurization of the immersion media 122. The sample window 116 can therefore stay in gapless contact with the sample holder 108 during repositioning and avoid air gaps between the sample window 116 and the sample 120. However, in some embodiments and use cases, some air gaps may nevertheless be permissible (particularly if the sample holder 108 is maintained orthogonal to the sample window 116). For example, the system may be designed to limit the air gaps to below a threshold tolerance that may be non-zero.

The flexible film for the objective window 114 and/or the sample window 116 may comprise an index-matched plastic film or other flexible and durable index-matched material. The material may furthermore be designed to withstand the pressures and movements associated with the operation of the microscope 100, including the movement of the objective 104 and the sample holder 108. The flexible film may also be designed to maintain its optical properties across millimeter-scale distances and throughout various materials. This may allow for sample scanning in three dimensions, while minimizing refractive index differences and dispersion differences. In further alternative embodiments, the illumination objective window 112 and/or the sample window 116 may comprise a rigid optical window instead of a deformable material.

The illumination objective window 112 may comprise a rigid window (e.g., hard plastic or glass) in some embodiments and air gaps between the illumination objective and the illumination objective window 112 may be permissible for general imaging applications. However, in an alternative embodiment, the illumination objective window 112 may also comprise a flexible film similar to that used in the objective window 112 and sample window 116 described above, which may reduce or eliminate the air gaps if desirable.

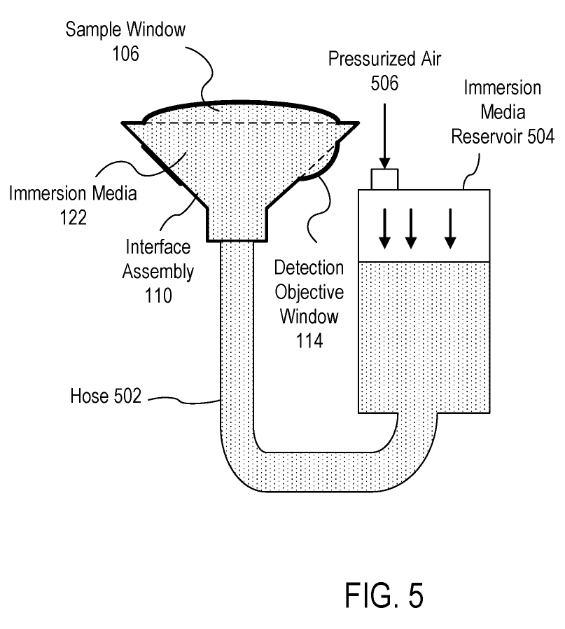

In an embodiment, the interface assembly 110 may be structured to maintain pressurization of the immersion media 122 such that it exerts an outward force on the flexible film(s) (e.g., the detection objective window 114 and/or sample window 116) which may further act to reduce or eliminate air gaps in the light paths. This pressurization can be provided pneumatically, hydraulically, or mechanically. For example, in one implementation, the interface assembly 110 may include a pressurization port 124 that that couples the chamber to an external reservoir and via a flexible or rigid hose that provides a fixed or controllable pressure internally to the chamber (e.g., as shown in FIG. 5 described in further detail below) In one such embodiment, the hose may be connected either directly to a secondary reservoir of immersion medium. The overall volume of immersion media can thus accommodate changes in shape and deformations of the main container as it adapts to movement of the samples and/or objectives. In a further embodiment, pressure in the chamber may be controlled via a pump.

In an embodiment, a clamp 126 may operate to apply downward pressure on the sample holder 108 to further reduce or eliminate air gaps between the sample holder and the sample window 116. The clamp 126 may be manually or electronically actuated.

In an embodiment, the sample 120 may be prepared in the sample holder 108 in a manner that avoids (or reduces) air gaps. For example, the sample 120 may be vacuum sealed within a bag or other container to eliminate air gaps in the light path between the sample 120 and the bottom of the sample holder 108. In some embodiments, the sample 120 may be sealed in an immersion media with matching refractive index.

In some embodiments, an immersion oil or other interface may be placed between the objective windows 112, 114 and corresponding objectives 102, 104 and/or between the sample holder 108 and the sample window 116 that may further operate to eliminate (or reduce) air gaps in the optical path. The immersion oil may comprise the same substance as the immersion media 122 in some embodiments. In another embodiment, the immersion oil may comprise a different substance that has a matching refractive index with the immersion media 122.

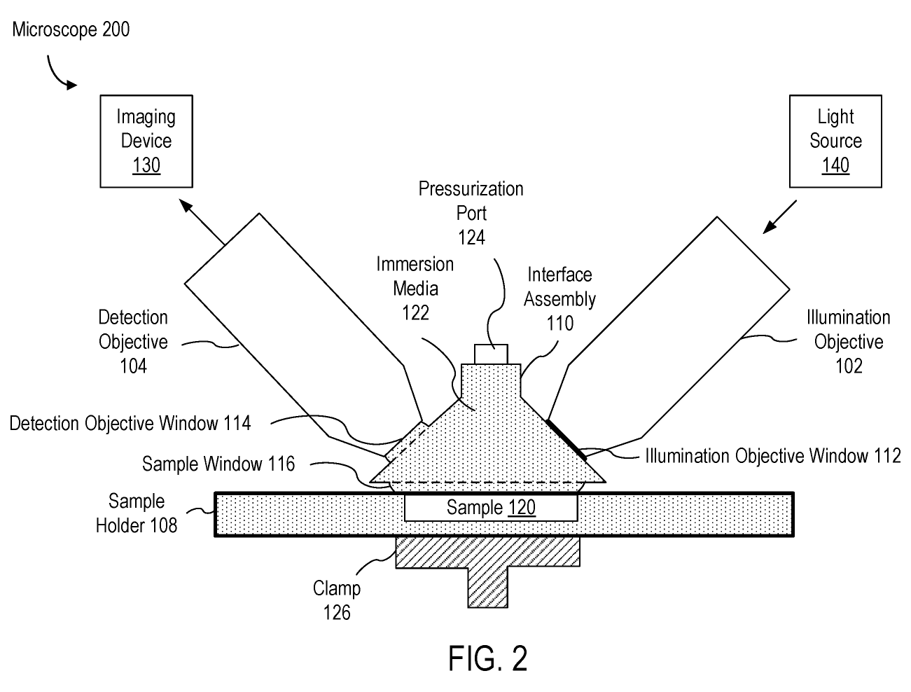

FIG. 2 illustrates another embodiment of a microscope 200. The microscope 200 operates according to similar principles described above, but may be structured such that the objectives 102, 104 are positioned to face downward (e.g., at 45 degrees from horizontal) and the sample is positioned below the objectives 102, 104. The clamp 126 may apply an upward pressure in this embodiment.

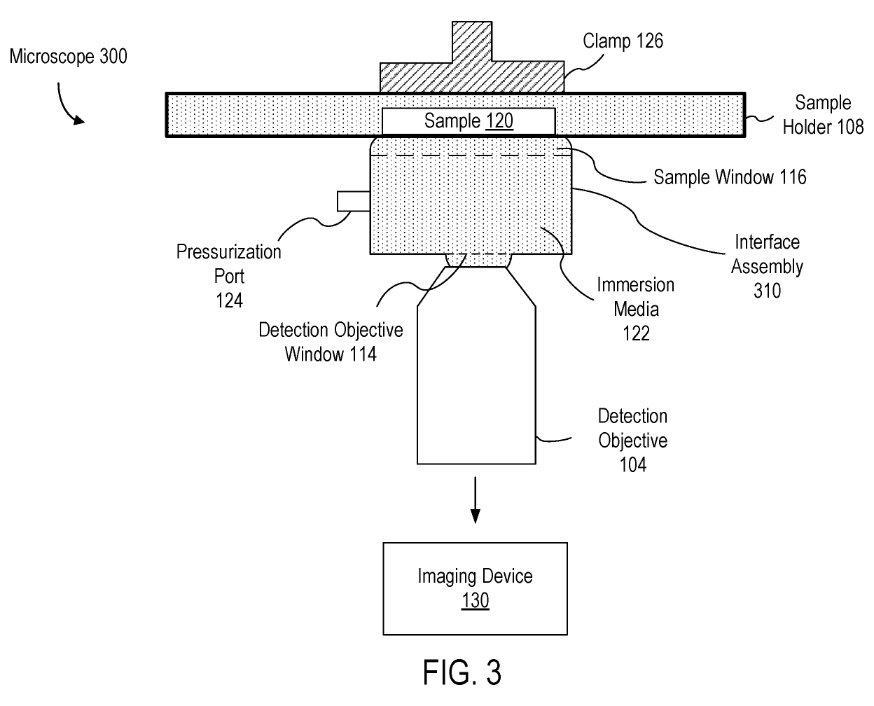

FIG. 3 illustrates another microscope configuration in which the microscope 300 includes only a detection objective 104 oriented perpendicular to a plane of the sample holder 108 (e.g., operating as a confocal microscope). The sample 120 may be supported above the detection objective 104 in this example. At least one of the sample window 116 and the detection objective window 114 may comprise a flexible film as described above. The immersion media 122 may be similarly pressurized via a pressurization port 124 and the sample holder 108 may be clamped by a clamp 126 to reduce or eliminate air gaps.

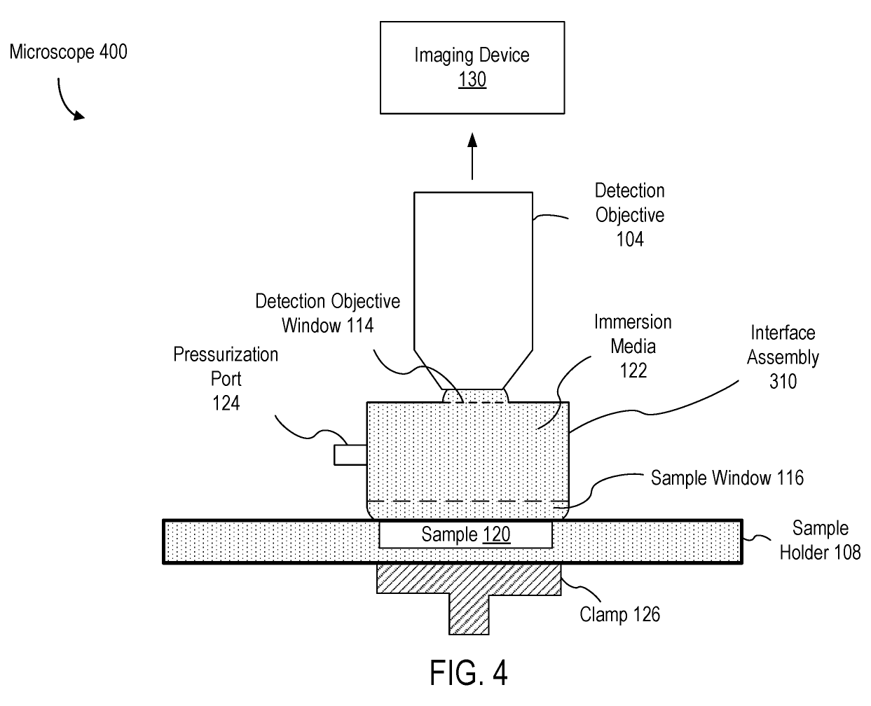

FIG. 4 illustrates another microscope 400. The microscope 400 may be configured as a confocal microscope with a detection objective 104 perpendicular to the plane of the sample holder 108 being imaged similar to FIG. 3, but with the detection objective 104 supported above the sample 120.

In further embodiments, the described interface assembly 110 may comprise an attachable device for retrofitting a traditional microscope. For example, the interface assembly 110 may include one or more integrated attachment and/or supporting mechanisms to enable attaching the interface assembly 110 between existing objectives 102, 104 and sample holder 108.

FIG. 5 illustrates an example embodiment of a pressurization device 500 for controlling pressure of the immersion media 122 in the interface assembly 110 (or interface assembly 310). In this embodiment, a hose 502 couples the chamber of the interface assembly 110 with an external reservoir 504 that may be pressurized with air 506. In this configuration, the immersion media 122 can flow in and out of the chamber of the interface assembly 110 as the sample window 116 and/or the detection objective window 114 deforms such that the chamber remains full and under sufficient pressure to avoid air gaps and to maintain gapless contact in the light path (or certain portion thereof). Alternatively, the system may operate to enable the air gaps to be within a threshold tolerance that may be non-zero for some applications. As can be seen the windows 116, 114 may have concave shape due to the internal pressure when not subjected to external forces from the detection objective 104 and/or sample holder 108.

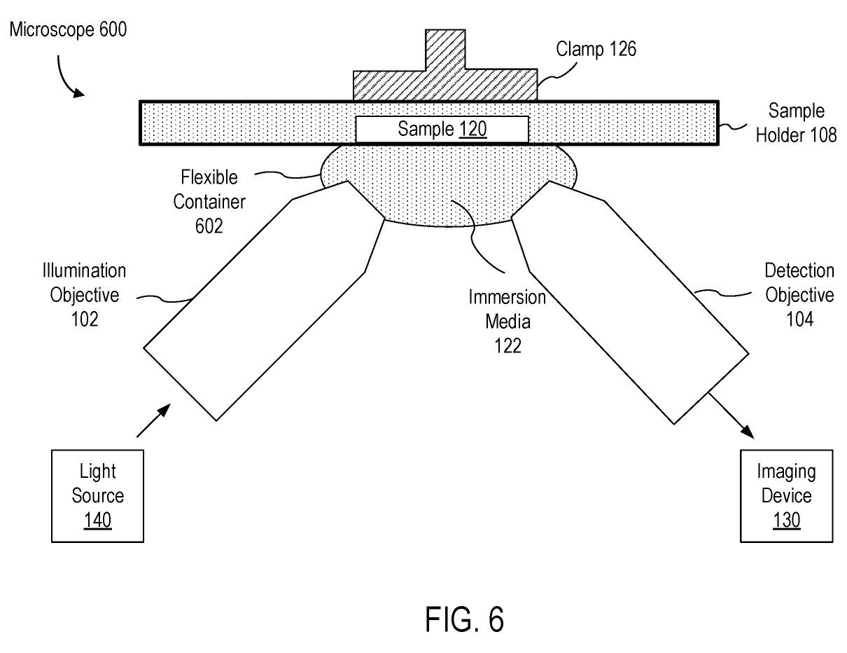

FIG. 6 illustrates another embodiment of a microscope 600. In this embodiment, a removable flexible container 602 attaches between the illumination objective 102, the detection objective 104, and the sample holder 108. The container 602 may be attached via a clipping mechanism that may include one or more clips designed to grip the flexible container 602 and hold it in place adjacent to the lens of the objectives 102, 104.

In another example, a sleeve may be used to attach the flexible container 602 to the objectives 102, 104 . This sleeve may be designed to slide over the objective and may include the flexible container as a pouch or pocket that covers the lens. The sleeve may be made from a flexible material that allows it to conform to the shape of the objective, thereby providing a secure and stable attachment for the flexible container 602. The sleeve may also be designed to be easily slid on and off the objective, thereby facilitating the setup and adjustment of the microscope system.

In yet other cases, other attachment mechanisms may be used to secure the flexible container 602 to the objectives 102, 104. These attachment mechanisms may include, for example, adhesive materials, magnetic attachments, or mechanical fasteners.

The flexible container 602 operates to provide similar benefits to the interface assembly 110 described above. By maintaining gapless contact with the objectives 102, 104 and the sample holder 108, the light paths may maintain optical properties during the movements and adjustments of the objectives 102, 104 and/or sample holder 108 thereby preserving the quality of the resulting images. The sealed nature of the container 602 may also protect the immersion media from contaminants, further enhancing the longevity and usability of the microscope 600. While the flexible container 602 enables such gapless contact to be achieved, in embodiments where the objectives 102, 104 are oriented orthogonally to their respective interfaces, air gaps may nevertheless be permissible without necessarily affecting image quality.

The flexible container 602 in this embodiment can also be pressurized to enhance contact between the deformable container 602 and the sample holder 108 and/or objectives 102/104. This pressurization can be provided pneumatically, hydraulically, or mechanically using any of the same mechanism described in the earlier embodiments.

While FIG. 6 shows an embodiment in which there are two objectives 102, 104 oriented at 45 degree angles from below the sample 120, the flexible container 602 may similarly be used in other microscope configurations described above. For example, the flexible container 602 may be used in place of the interface assembly 110 in a configuration in which the sample holder 108 is below the objectives 102, 104. The flexible container 602 may also be used in place of the interface assembly 310 in microscopes with an objective oriented at 90 degrees relative to the plane of the sample holder 108 (from either above or below the sample 120).

In further alternative embodiments, the flexible container 602 may include one or more sections of rigid walls and one or more flexible windows for interfacing with one or more objectives 102, 104 and/or the sample holder 108.

In further embodiments, the described interface assembly 110 and/or the flexible container 602 may be utilized in microscopes having a single objective, two objectives, or more than two objectives. Furthermore, objectives may be oriented at different angles than those shown in the examples.

Examples of suitable microscope systems may include Selective Plane Illumination Microscopy (SPIM) systems, confocal microscopes, two-photon microscopes, and widefield microscopy systems.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention.

1. A microscope system, comprising:
a detection objective including magnifying optics;
a sample holder for holding a sample in view of the detection objective;
an interface assembly positioned between the detection objective and the sample holder, the interface assembly comprising:
a chamber for containing an immersion media;
a sample window providing a first optical path between an exterior and interior of the chamber, the sample window comprising a deformable material for interfacing with the sample holder to allow movement of the sample while maintaining gapless contact with the sample holder; and
a detection objective window providing a second optical pathway between the exterior and the interior of the chamber, the detection objective window to optically interface with the detection objective.

2. The microscope system of claim 1, wherein the detective objective window comprises a deformable material to allow movement of the detection objective while maintaining gapless contact with the detection objective.

3. The microscope system of claim 1, wherein the interface assembly comprises a pressurization port for fluidly coupling the interior of the chamber to a pressurization mechanism that enables pressurization of the immersion media to enhance the gapless contact of the sample window with the sample holder.

4. The microscope system of claim 3, wherein the pressurization mechanism comprises at least one of a pneumatic, hydraulic, or mechanical pressurization mechanism.

5. The microscope system of claim 3, wherein the pressurization mechanism comprises:
a hose coupled to the pressurization port; and
an external reservoir containing reserve immersion fluid that operates to maintain pressure of the immersion media in the chamber in response to varying forces on the deformable material of the sample window.

6. The microscope system of claim 3, wherein the sample is vacuum sealed in the sample holder within a media having a refractive index matching the immersion media of the interface assembly.

7. The microscope system of claim 1, further comprising:
a clamping mechanism to apply a force on the sample holder to actively enforce the gapless contact between the sample holder and the sample window.

8. The microscope system of claim 1, further comprising:
an illumination objective including illumination optics for focusing light from a light source onto the sample,
wherein the interface assembly is further positioned between the illumination objective and the sample holder,
wherein the interface assembly further comprises an illumination objective window providing a third optical pathway between the exterior and the interior of the chamber, the illumination objective window to interface with the illumination objective.

9. The microscope system of claim 8, wherein the illumination objective window comprises a rigid material.

10. The microscope system of claim 8, wherein the detection objective and the illumination objective are oriented for imaging from below a plane of the sample holder.

11. The microscope system of claim 8, wherein the detection objective and the illumination objective are oriented for imaging from above a bottom surface of the sample holder.

12. The microscope system of claim 1, wherein the detection objective is orientated approximately perpendicular to a plane of the sample holder.

13. A microscope system, comprising:
at least one objective including magnifying optics;
a sample holder for holding a sample in view of the objective; and
a light source to illuminate the sample; and
a flexible container positioned between the objective and the sample, the flexible container containing an immersion medium with a refractive index matched to the sample, wherein the flexible container is deformable to allow movement of the sample and adjustment of the objective while maintaining gapless contact with at least one of the sample and the objective.

14. The microscope system of claim 13, wherein the flexible container comprises a sealed bag made from a flexible film.

15. The microscope system of claim 13, wherein the sample is vacuum sealed within an immersion medium having a refractive index matching the immersion medium of the flexible container.

16. The microscope system of claim 13, further comprising an attachment mechanism configured to secure the flexible container to the objective, wherein the attachment mechanism comprises at least one of: a clip, a sleeve, an adhesive material, a magnetic attachment, or a mechanical fastener.

17. The microscope system of claim 13, further comprising:
a clamping mechanism to apply a force on the sample holder to actively enforce the gapless contact between the sample holder and the flexible container.

18. An interface assembly for a microscope system, comprising:
a rigid body for positioning between an objective and a sample holder and for containing an immersion medium with a refractive index matched to a sample;
a flexible sample window through the rigid body comprising a deformable film, the deformable film for interfacing with a sample holder to allow movement of the sample while maintaining gapless contact with the sample,
at least one objective interface to interface with at least one objective of the microscope system; and
a pressurization mechanism to pressurize an interior chamber of the rigid body to enhance the gapless contact of the flexible sample window with the sample.

19. The interface assembly of claim 18, wherein the objective interface comprises a deformable material to allow movement of the at least one objective while maintaining gapless contact with the at least one objective.

20. The interface assembly of claim 18, further comprising:
an illumination objective window to interface with an illumination objective.
